(19) United States
(12) Patent Application Publication
(10) Pub. No.: US 2004/0146381 A1
(43) Pub. Date: Jul. 29, 2004

(54) Silo unloader

(75) Inventors: Gregg W. Hanson, Spicer, MN (US); Howard D. Jacobson, Lake Lillian, MN (US)

Correspondence Address: NIKOLAI & MERSEREAU, P.A., 900 SECOND AVENUE SOUTH, SUITE 820, MINNEAPOLIS, MN, 55402, US

(73) Assignee: Hanson Silo Company, Lake Lillian, MN (US)

(21) Appl. No.: 10/350,197

(22) Filed: Jan. 23, 2003

(51) Int. Cl. B65G 65/00

(52) U.S. Cl. 414/306

(57) ABSTRACT

The silo unloader having one or more augers journaled for rotation therein is arranged to travel in a circular manner within a tower silo to auger silage to a collection point at the center thereof. Located proximate the central collection point is a transfer conveyor comprising two vertically oriented snowmobile track assemblies arranged to have corresponding flights of the track belt engaged with one another. As the tracks are driven by an electric motor, silage becomes entrained between the two adjacent tracks and is propelled therealong onto a discharge conveyor that leads to a drop chute opening in the wall of the silo.

### Background of the Invention

I. Field of the Invention

This invention relates generally to a machine for removing silage from a tower silo, and more particularly to a silo unloader having an improved transfer assembly for moving silage from a collection point proximate the center of the tower silo to a discharge conveyor leading to a drop chute opening in the silo wall.

II. Discussion of the Prior Art

In the Hanson et al. U.S. Pat. No. 5,642,977, the contents of which are incorporated herein by reference, there is described a silo unloader having a stationary frame that is adapted to be suspended from the top of the silo which can be lowered as the silage is removed. The frame includes a relatively large diameter guide ring from which an auger arm is suspended and means are provided for rotating the auger arm in a horizontal plane to sweep out a circular path. Contained within the auger arm is a pair of augers that are adapted to dig into the compacted top layer of silage to loosen it and carry it to a collection point that is proximate the center of the guide ring. Located at the collection point is an electric motor-driven blower having spinning paddles that throw the loosened silage against a discharge spout directed at the drop chute opening in the silo wall.

While the device depicted in the Hanson et al. '977 patent was found to be a considerable improvement over the prior art in the way that the auger arm was configured to break up compacted and sometimes frozen silage, the use of the blower to move the loosened silage from the collection point to the drop chute opening tended to be somewhat slow and inefficient, especially when longer cut hay silage and silage with a large moisture content needs to be moved.

It is a principal object of the present invention to provide a silo unloader having an improved silage transfer mechanism for moving silage augured to a collection point onto a discharge conveyor leading to a drop chute opening in the silo's wall.

Another object of the present invention is to provide a silage transfer mechanism capable of accommodating relatively large clumps of compacted silage without jamming or plugging.

A further object of the present invention is to provide a silo unloader system, which more efficiently unloads silage at a faster rate than previously possible while at the same time using less electrical power.

### SUMMARY OF THE INVENTION

The present invention provides a silo unloader similar in many respects to the prior art silo unloader described in the aforereferenced Hanson et al. '977 patent. That design is modified, however, by substituting a pair of commercially-available snowmobile track assemblies for the blower of the '977 patent. In accordance with the invention, the first and second endless belts comprising the snowmobile tracks are each deployed about a set of spring-loaded idler or bogey wheels to define adjacent parallel belt flights that extend from the collection point at the terminus of the auger arm toward the discharge conveyor leading to the selected drop chute opening. A drive means is coupled to provide a driving force to the first belt and that driven belt powers the second endless belt. Also, the same drive means powers the auger arm for rotating it in a generally horizontal plane and the augers themselves that are carried by the auger arm. Because the pinching characteristics of the twin belts wads of hay silage as well as large clumps of loosened, wet silage can be captured between the adjacent belt flights and carried to the discharge conveyor without jamming or plugging.

### BRIEF DESCRIPTION OF THE DRAWINGS

The foregoing features, objects and advantages of the invention will become more apparent to those skilled in the art from the following detailed description of a preferred embodiment, especially when considered in conjunction with the accompanying drawings in which like numerals in the several views refer to corresponding parts.

FIG. 1 is a perspective view of a preferred embodiment of the preferred silo unloader of the present invention;

FIG. 2 is a partial perspective view showing a pair of snowmobile track assemblies used in place of a prior art blower in a silage unloader; and

FIG. 3 is a side elevational view of the silage transfer mechanism of the present invention.

### DESCRIPTION OF A PREFERRED EMBODIMENT

As those skilled in the art appreciate, a silo unloader is adapted to be placed in the interior of a cylindrical tower silo in which a silage crop is stored. Over time, due to its own weight and due to decomposition of the vegetable material, the silage stored becomes compacted and melded within the silo. When it is desired to retrieve silage from the silo to feed to cattle or the like, a silo unloader is used to remove quantities of silage from the top surface thereof and feed it through a selected one of a plurality of vertically aligned drop chute openings in the silo wall. Once ejected through the opening, it falls through the chute to the ground to be fed to cattle.

The silo unloader is indicated generally by numeral 10 and it is seen to include a rotational guide ring 12 that is adapted to be secured by cables 14 and pulleys and then down to a winch (not shown) that is secured at the bottom of the tower silo whereby the entire assembly 10 can be periodically lowered onto the exposed upper surface of the silage by an operator on the ground. Mounted for rotation to the guide ring 12 is an auger arm assembly 16. More particularly, the guide ring 12 has a laterally extending flange 18 providing a surface upon which rollers as at 20 and 22 may ride. The flange 18 further includes regularly spaced openings, as at 19. The rollers are coupled to the auger arm assembly 16 so as to be suspended by the rollers 20 and 22 as well as additional rollers (not shown) affixed to rear frame members 24. As will be further explained hereinbelow, a drive means is provided for rotating the auger arm assembly 16 beneath the guide ring 12 so as to rotate in a generally horizontal plane to sweep circumferentially across the silage.

Wheels, as at 26, 28 30 and 31, are affixed to the frame comprising the auger arm 16 and are designed to cooperate with the cylindrical wall of the tower silo to maintain the silo unloader device 10 centered therein.

The auger arm assembly 16 comprises a pair of parallel side frame members 32 and 34 having cross plates 36 and 38 for maintaining frame members 32 and 34 in parallel, spaced-apart relationship with respect to one another. Extension bars 35 and 37 support a counterweight 39 to maintain the auger arm level. Journaled for rotation in bearings (not shown) supported by the cross-members 36 and 38 are counter-rotating augers 40 and 42 that are coupled to a drive motor 75 by a suitable gear box transmission, like that shown in the '977 patent, in a direction to advance silage augured out from the compacted mass to a collection point, indicated generally by numeral 44. Affixed to the outer ends of augers 40 and 42 are scraper wheels 45 that loosen silage that may become frozen to the silo wall.

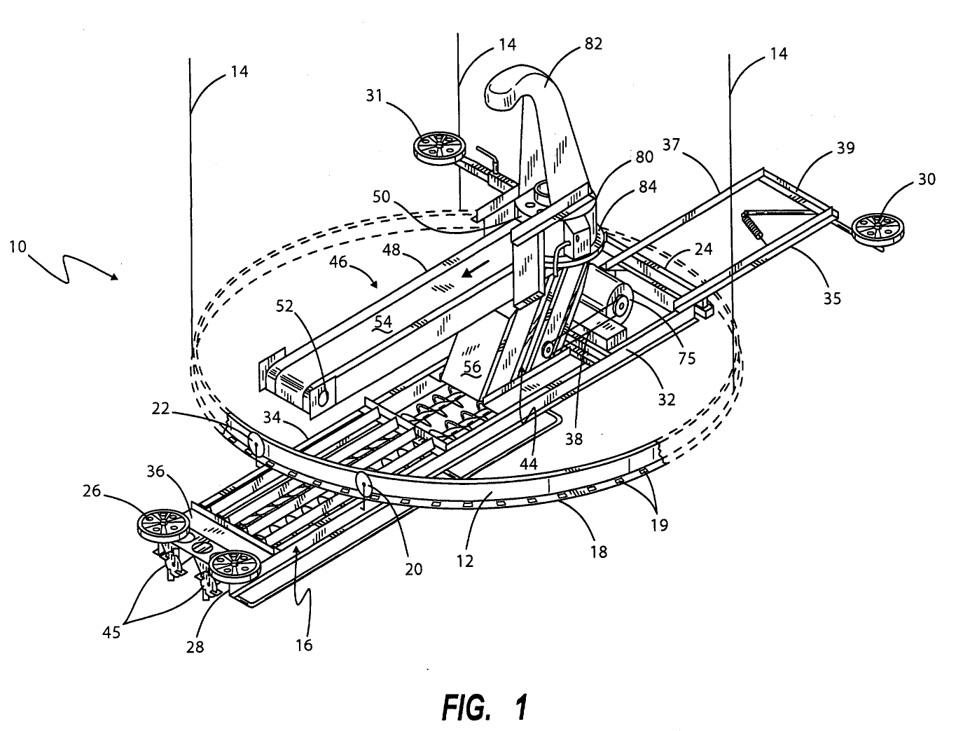

With reference again to FIG. 1, the silo unloader 10 further includes a discharge conveyor 46 having a frame 48 supporting a drive roller 50 at a first end thereof and a nose roller 52 at the opposite end. An endless belt 54 is entrained over the rollers 50 and 52 so that the upper flight of the conveyor belt 54 moves in the direction of the arrow marked on the belt. The discharge conveyor 54 is aligned with a drop chute opening in the wall of the silo tower such that silage deposited on the belt 54 will be ejected out through the drop chute opening.

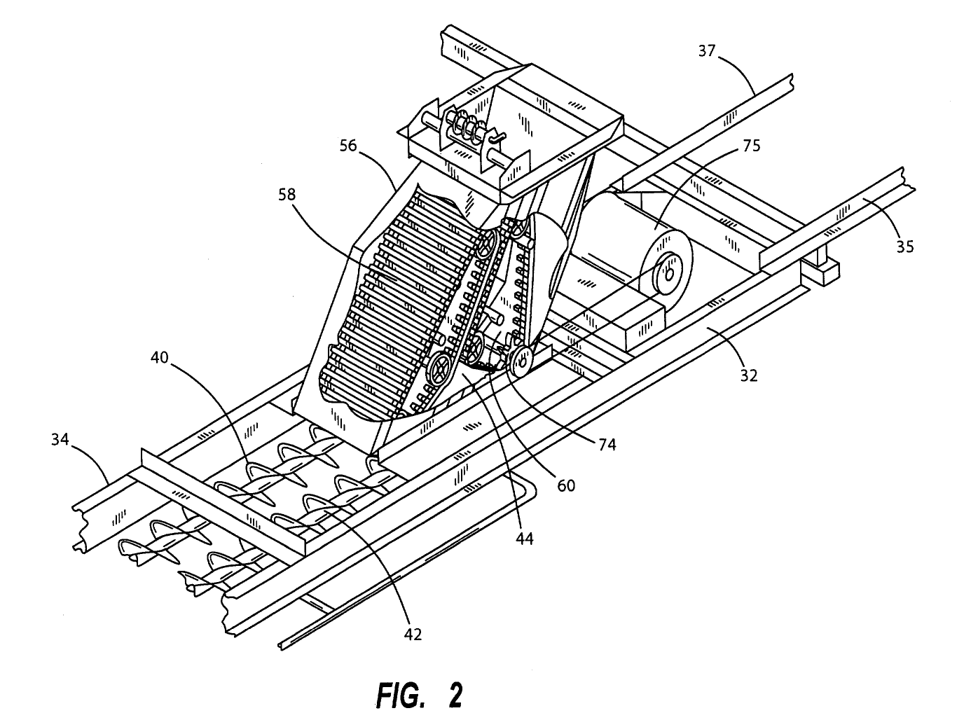

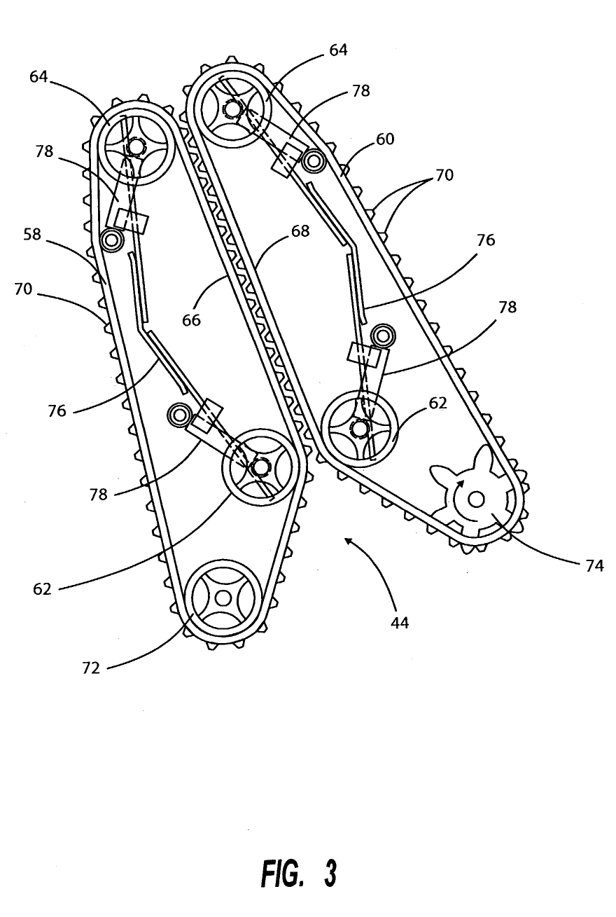

In that the manner in which the augers operate to scrape and carry silage to the collection point 44 is fully set out in the aforereferenced Hanson et al. '977 patent, it need not be repeated here. Suffice it to say, the blower mechanism for transferring silage from the collection point to the discharge conveyor 54 of the '977 patent is replaced by a pair of cooperating snowmobile track assemblies, as seen in FIGS. 2 and 3 hereof.

Referring to FIG. 2, contained within a protective shroud 56 formed from sheet metal are first and second endless belts 58 and 60 of a type used on commercially available snowmobiles that are deployed over a set of spring-loaded bogey wheels 62 and 64 to define adjacent parallel belt flights 66 and 68. The parallel belt flights are placed sufficiently close to one another such that lugs 70 on the exterior surfaces of the belts 58 and 60 will engage one another. The endless belt 58 is deployed over an idler roller 72 while the belt 60 is deployed over a cast iron drive sprocket 74 whose teeth are arranged to pass through sprocket holes formed through the thickness dimension of the belt 60. Metal clips (not shown) are used to reinforce the sprocket holes. Thus, as the sprocket wheels 74 is driven in a clockwise direction, when viewed in FIG. 3, by the motor 75 (FIG. 1), the belt 58 will move in a counterclockwise direction about the idler pulley 72.

In the snowmobile track suspension system employed in creating a working embodiment of the invention, the bogey wheels 62 and 64 are journaled for rotation in bearings 78 that are joined together by leaf springs, as at 76. The leaf springs allow the spacing between the parallel flights 66 and 68 to vary somewhat as different quantities of silage in sheets and clumps are carried along between the flights 66 and 68.

With continued reference to FIG. 2, as the augers 40 and 42 scrape off and carry compacted silage from the wall area of the silo to the collection point 44, the silage becomes entrained between the adjacent parallel flights of the snowmobile track belts 58 and 60 which are driven at a relative high speed to discharge the silage through a collector ring 80 affixed at the top of the shroud 56 and against an arcuate deflector 82 such that it is made to fall on the discharge conveyor belt 54.

The collector ring 80 includes an electrical slip ring device 84 by way of which electrical current is delivered, via a cable (not shown), to the drive motor 75 while still permitting rotation of the auger arm assembly 16 about the guide ring 12. As in the aforereferenced Hanson et al. '977 patent, the flange 18 of the guide ring 12 includes regularly spaced apertures 19 that are adapted to be engaged by a cogwheel, also driven by the motor 75 through a suitable transmission, to effect rotation of the auger arm assembly.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself

What is claimed is:

1. In a silo unloader for removing silage from a tower silo by propelling silage out of a drop chute opening of the silo, the silo unloader being of the type including a frame adapted to be suspended within the silo from an upper portion thereof, an auger arm coupled to the frame for moving the silage to a collection point, the auger arm having a pair of cooperating augers journaled therein and adapted to rotate relative to the frame in a generally horizontal plane to sweep circumferentially across the silage and a discharge conveyor leading to the drop chute opening, the improvement comprising:
(a) first and second endless belts, each deployed about a set of spring-loaded bogie wheels to define adjacent parallel belt flights extending from the collection point toward the discharge conveyor and adapted to capture silage therebetween; and
(b) drive means for providing a driving force to the first and second endless belts, the pair of augers and a force for rotating the auger arm in said generally horizontal plane.

2. The silo unloader as in claim 1 wherein the first and second endless belts each include regularly spaced lugs on an outer surface thereof, the lugs on the first endless belt engaging the lugs on the second endless belt.

3. The silo unloader as in claim 2 wherein at least one of the first and second endless belts includes a pattern of regularly spaced sprocket holes therethrough and the drive means includes a sprocket wheel for cooperating with the sprocket holes on the at least one of the first and second belts.

4. The silo unloader as in claim 1 wherein the spring-loaded bogie wheels resiliently urge the adjacent parallel flights of the first and second endless belts against one another.

5. The silo unloader as in claim 1 wherein the frame includes a stationary guide ring for supporting the auger arm for rotation therealong and the collection point is proximate a center of the guide ring.

6. A silo unloader for removing silage from a tower silo by propelling silage out of a drop chute opening of the silo comprising, in combination:
(a) a frame adapted to be suspended within a tower silo from an upper portion thereof, said frame including an annular track;
(b) an auger arm suspended from the frame for travel over a circular area, the auger arm having at least one auger journaled for rotation therein and adapted to scrape and move silage from a perimeter of the tower silo to a collection point proximate a center of the annular track;
(c) an elongated discharge conveyor affixed to the frame and having a bed supporting an endless conveyor belt driven by a first drive means, the discharge conveyor being alignable with the drop chute opening; and
(d) a transfer assembly for moving silage from the collection belt onto the discharge conveyor, said transfer assembly including a pair of endless belts entrained over bogey wheels to define a path between two adjacent, parallel belt flights and driven by a second drive means.

7. The silo unloader as in claim 6 wherein the second drive means is coupled to rotate the at least one auger while the auger arm traverses the annular track.

8. The silo unloader as in claim 7 wherein the pair of endless belts comprise a pair of snowmobile drive track assemblies positioned so that a predetermined flight of each are engaged to one another.

9. The silo unloader as in claim 8 wherein the bogey wheels are resiliently mounted to permit limited separation of the predetermined flights from one another.

10. The silo unloader as in claim 6 wherein the first and second drive means each comprises an electric motor.

11. The silo unloader as in claim 6 wherein the electric motor comprising the first drive means is affixed to the bed of the discharge conveyor.

12. The silo unloader as in claim 6 wherein the electric motor comprising the second drive means is supported by the auger arm for rotation therewith and electric power is supplied to the motor through a slip ring connection.
